(19) United States
(12) Patent Application Publication
(10) Pub. No.: US 2017/0047664 A1
(43) Pub. Date: Feb. 16, 2017

(54) FREE SPACE ABSORBER

(71) Applicant: UNIWERSYTET WROCLAWSKI, Wroclaw (PL)

(72) Inventors: Andrzej VOGT, Wroclaw (PL); Stanislaw STRZELECKI, Wroclaw (PL); Slawomir SZAFERT, Wroclaw (PL)

(73) Assignee: UNIWERSYTET WROCLAWSKI

(21) Appl. No.: 14/854,865

(22) Filed: Sep. 15, 2015

(30) Foreign Application Priority Data
Aug. 14, 2015 (PL) PL413567

(51) Int. Cl. H01Q 17/00; H01Q 15/14

(52) U.S. Cl. CPC H01Q 17/008; H01Q 15/14

(57) ABSTRACT

The free space absorber based on an absorbent material containing conductive dipoles dispersing EM waves, includes a conductive substrate reflecting EM waves and a conductive grid located on the surface of the absorber.

### RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

Field of the Invention

The object of the invention is a broadband free space absorber improving the efficiency of energy absorbers of electromagnetic (EM) waves, which is placed on a conductive substrate which reflects EM waves, in the form of a metallic mirror.

2. Description of Related Art Including Information Disclosed Under 37 CFR 1.97 and 37 CFR 1.98.

On the surface of the absorber, a conductive grid is placed which significantly improves the efficiency of materials absorbing energy of electromagnetic (EM) waves.

An examplary purpose of this absorber is, e.g., to protect facilities/premises against electromagnetic waves, including HPM (High Power Microwaves) type of pulses, penetrating thereto from the outside, and against EM waves (data carriers) getting out, or “leaking”, outside of these facilities.

The free space absorber according to the invention envisages introduction, to a mass which absorbs electromagnetic (EM) waves, of special elements, metallic fibres (dipoles), e.g. in the form of wires dispersing these waves in its interior, and relates to the structure itself of the absorber.

Dispersion of an EM wave incident on such an absorber consists in secondary generation of EM waves on conductive fibres (dipoles) of various, due to their different lengths, frequencies and thus creating a definitely larger possibility of their propagation along the absorber rather than just across it, which promotes their increased additional absorption.

The absorber according to the invention improves the efficiency and effectiveness of EM wave absorption.

From document U.S. Pat. No. 5,661,484, a dielectric material with randomly distributed fibres of a conductor, graphite, nickel or stainless steel, of a predetermined size, thickness and shape, described as “conductive filling”, “dipoles”, is known. The material dedicated to absorb radar waves of a wide range of frequencies.

From document U.S. Pat. No. 4,606,848 A, a paint with sunken conductor fibres dispersing electromagnetic radiation referred to as “dipoles” is known.

From document 20040020674, composite materials in configurations, among others, absorber/conductor; absorber/conductor/dielectric filler;

absorber/conductor/dielectric filler with a filling with fibres or granules of the conductor or of the absorber.

From specification U.S. Pat. No. 3,526,896 A, an absorbent material is known, composed of two layers, of which an absorbent layer composed of a binder and absorbent granules may also contain sunken dipoles produced with the participation of either well conductive metals or conductive polymers.

From document U.S. Pat. No. 6,869,683, a layer reflecting electromagnetic waves is known, having an electrically conductive filler (in the form of powder with particle diameter of 0.1 μm to about 100 μm) dispersed in a silicone resin. The filler from the description (embodiments): metallic base filler includes aluminum, zinc, iron, copper, nickel, silver, gold, palladium and stainless steel in the form of powder, flakes or fibres.

Document WO/2004/079862 describes the use, in the absorber, of carbon fibres, chopped carbon fibres or glass fibres as a material capable of limiting the flow rate of electric current. These fibres are randomly distributed.

Application US20070052575 describes a conductive material that may be in the form of powder, fine powder, lumps, nap, planar structure or fibre. The conductive material may be a carbon-based material, examples thereof including: carbon nanofibre, carbon nanotubes, carbon graphite and fullerene.

### SUMMARY OF THE INVENTION

The essence of the invention is a free space absorber based on an absorbent material containing conductive dipoles dispersing EM waves, characterised in that it comprises a conductive substrate reflecting EM waves and a conductive grid located on the surface of the absorber.

Preferably, the absorbent material is constituted by: a dielectric material and/or a magnetic material and/or a magnetic dielectric material.

Preferably, the substrate reflecting EM waves is planar or shaped in regular spatial structures.

Preferably, the conductive dipoles constitute metallic and/or non-metallic antennas dispersing EM waves.

Preferably, the conductive grid is metallic or non-metallic.

Preferably, the conductive grid has a two- or three-dimensional structure.

Preferably, the conductive grid is placed on the surface of the absorbent material.

Preferably, the conductive dipoles are distributed stochastically or non-stochastically in the absorbent material.

Preferably, the conductive dipoles have equal or unequal dimensions and shapes.

Preferably, the absorber comprises a layer of dielectric material located on the underside of the absorbent material.

Preferably, the layer of dielectric material contains conductive dipoles dispersing EM waves.

Preferably, the conductive dipoles dispersing EM waves contained in the layer of dielectric material constitute metallic and/or non-metallic antennas dispersing EM waves which are distributed stochastically or non-stochastically, wherein they have equal or unequal dimensions and shapes.

Preferably, the absorber additionally comprises additional spatial elements made of attenuative materials.

Preferably, as the attenuative materials, dielectric or magnetic attenuative materials having different magnetic and dielectric parameters than the absorbent material are used.

Preferably, the spatial elements made of attenuative materials are located within the absorbent material.

Preferably, the spatial elements are located on a dielectric layer.

Preferably, the spatial elements are covered with an excess of absorbent mass.

Preferably, the absorber comprises a layer of dielectric material separating the conductive substrate from the absorbent material.

The free space absorber according to the invention is characterised in that a wave of a predetermined length incident on the absorber made of a substance having specific magnetic and dielectric properties (preferably with maximum possible losses across a wide range of frequencies), after a partial reflection, when entering its interior, encounters generally conductive, constituting mini-antennas, metallic fibres stochastically distributed therein, which leads to dispersion thereof already in the form of new waves, in multiple directions within the mass absorbing it.

An additional element enhancing absorption throughout the mass of the absorber is the use of a conductive substrate which reflects EM waves in the form of a classic metallic flat mirror from which the dispersed waves are reflected and additionally absorbed by the absorbent mass.

On the external surface of the absorber containing dispersed metallic fibres, metallic spatial 2D (e.g. grids) or 3D (e.g. crates) elements are placed, i.e. elements having regularly distributed structures reflecting and dispersing the wave incident on the absorber.

This layer can be treated as a first barrier against a wave or a pulse (e.g. HPM) penetrating deep into the absorber.

In a preferred embodiment, in order to enhance the absorption of the dispersed wave throughout the mass of the absorber with suspended metallic conductive fibres, an appropriately formed mirror (e.g. in the form of pyramids), and not a classic planar metallic mirror, is used, thereby obtaining an additional attenuation of dispersed waves, which this time has phase characteristics but is still within the absorber.

In another embodiment, providing additional effects of attenuating waves dispersed in the wave absorber, three-dimensional spatial elements located on a flat metallic mirror, made of an absorbent mass having different attenuative parameters (different μ′, μ″, ∈′ and ∈″ values) than the absorbent material of the absorber, and embedded with this mass are used.

In the described case, the following is obtained;
an additional surface of reflection for waves dispersed by fibres in the primary absorbent mass of the absorber from the surface of appropriately formed elements, thereby providing not only an effect of attenuation in the absorber mass but also an additional effect of attenuation of these reflected waves.

Moreover;
the wave which penetrated through the surfaces of spatial elements with different attenuative parameters to their interior is absorbed by the material of which they are made, and after another dispersion thereof, by metallic fibres if they are present in these elements,
furthermore, reflection of waves dispersed in spatial attenuative elements from the flat metallic mirror promotes their additional absorption.

Another solution according to the invention, which enhances the absorption of the wave distributed throughout the absorber mass, is to introduce conductive fibres dispersing EM waves, this time not to the absorbent mass but to the dielectric layer located in the conductive substrate in the form of a metallic mirror, separating this mirror from the mass.

The introduction of the dielectric layer separating the absorbent mass from the metallic mirror to the absorber structure aims at creating additional surface of reflection for the wave passing through the free space absorber.

In turn, the introduction of the conductive fibres to the dielectric layer has a similar meaning as described for the absorbent material, i.e. allows change of the direction of wave propagation with a simultaneous possibility for their repeated reflections from the metallic mirror and from the surface of the specific absorber mass together with a possible effect of attenuation and re-entry of the waves into the said absorbent mass.

As the absorbent masses, both dielectric substances having high losses (here, absorption of electric component only) and magnetic materials exhibiting losses both on magnetic and dielectric sides (here, absorption of both components of EM field) can be used.

Of course, it is recommended to use materials and substances exhibiting lossy magnetic properties.

In the prior art solutions of commonly used free space absorbers (polymeric shaped blocks optionally saturated with attenuative materials, e.g. ferrite powders or graphite), primarily, their shape and, to a lesser extent, absorption properties of the material contributed to their effectiveness.

Shaped blocks made of solid ferrites have a slightly greater role in the attenuation but are rather rarely used due to their high cost, brittleness and specific gravity.

The suggested solution significantly enhances the effectiveness of free space absorbers with their specific shapes and their used specific absorbent materials during attenuation of EM waves and pulses, including HPM, penetrating inside the protected facilities and premises and preventing EM waves from escaping from these facilities.

It seems that the use of broadband magnetic materials described in document GB2379331 A to create free space absorbers discussed herein is the most rational and the most preferred from both technological and economic points of view.

This is a new generation of composite magnetic materials exhibiting attenuative properties in a wide frequency band from distant kHz up to dozens of GHz. They have significantly lower density than solid ferrites, may take any physical form, from liquids, foams, adhesives, sealants, paints, plastic, flexible, up to solid, hard masses.

They can be extrudable or non-extrudable.

The absorbent material can be both:
a dielectric material having high losses of electric component of EM wave, characterised by appropriate ∈′ and ∈″ values, and
a magnetic material having high losses of both magnetic and electric components of EM wave, characterised by appropriate μ′, μ″ and ∈′, ∈″ values, wherein magnetic dielectric materials are preferably used.

Spatially formed materials made of a conductive material are constructed with similar materials, differing only in μ′, μ″, ∈′ and ∈″ parameters.

Conductive dipoles in the form of metallic antennas should be stochastically distributed in the absorbent material and have various lengths and shapes (needles, rings, etc.).

The free space absorber may be constructed both in the form of
rigid or flexible flat structures, in the shape of plates, strips, tapes, etc. having a thickness and material composition of the substance absorbing energy of EM waves, selected from the point of view of its effectiveness and scope of operation,
rigid or flexible spatial structures (pyramids, crates, toruses), in the shape, size and material composition of the substance absorbing energy of EM waves, selected from the point of view of its effectiveness and scope of operation.

The surface of the free space absorber is covered with a metallic grid with regular shapes of meshes and two-dimensional or three-dimensional geometrical structure.

Furthermore, mainly in the case of flat absorbers, in order to significantly increase the attenuation effect of the absorber, the metallic mirror may be shaped in the form of e.g. regularly distributed spatial structures, e.g. pyramids with appropriately selected dimensions.

Additionally, the absorber may contain spatial structures which may be made of an absorbent material having different attenuative properties than the primary layer of absorbent material.

In a preferred embodiment, these elements are fixed to the dielectric layer and embedded with the primary absorbent (attenuative) mass.

In a preferred embodiment, flat layers made of a dielectric having a properly selected thickness may be used, which are placed on a flat conductive substrate in the form of a metallic mirror, thereby separating this mirror from a dielectric or magnetic dielectric attenuative mass shaped in the form of a flat structure or a spatial structure.

They can also contain metallic fibres (dipoles) stochastically distributed in their structure.

In a preferred embodiment, flat layers made of a dielectric having a properly selected thickness may be used.

The dielectric layer may not contain or may contain, which is very advantageous, metallic micro-dipoles stochastically distributed in their structure.

### BRIEF DESCRIPTION OF THE DRAWINGS

The invention is more closely presented in embodiments below and in the drawings.

FIG. 1 shows a schematic view of a free space absorber made of an absorbent mass with metallic dipoles suspended therein, placed on a conductive substrate in the form of a flat, metallic mirror with a metallic grid on its surface.

FIG. 2 shows a schematic view of a free space absorber made of an absorbent mass with metallic dipoles suspended therein, placed on a conductive substrate in the form of a metallic mirror shaped as pyramids with a metallic grid on its surface.

FIG. 3 shows a schematic view of a free space absorber made of an absorbent mass with metallic dipoles suspended therein, containing pyramid-shaped spatial elements placed on a conductive substrate in the form of a flat, metallic mirror with a metallic grid on its surface.

FIG. 4 shows a schematic view of a free space absorber made of an absorbent mass with metallic dipoles suspended therein, distributed across a dielectric layer separating it from a conductive substrate in the form of a metallic mirror with a metallic grid on its surface.

FIG. 5 shows a schematic view of a free space absorber made of an absorbent mass with metallic dipoles suspended therein, distributed across a dielectric layer, containing pyramid-shaped spatial elements, wherein the dielectric is placed on a flat conductive substrate in the form of a metallic mirror with a metallic grid on its surface.

FIG. 6 is the legend for FIGS. 1-5.

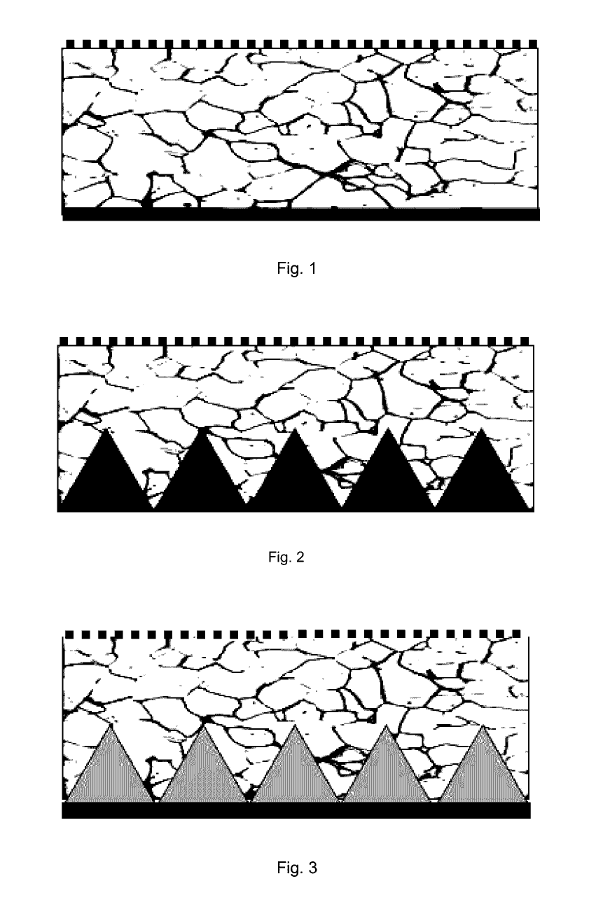

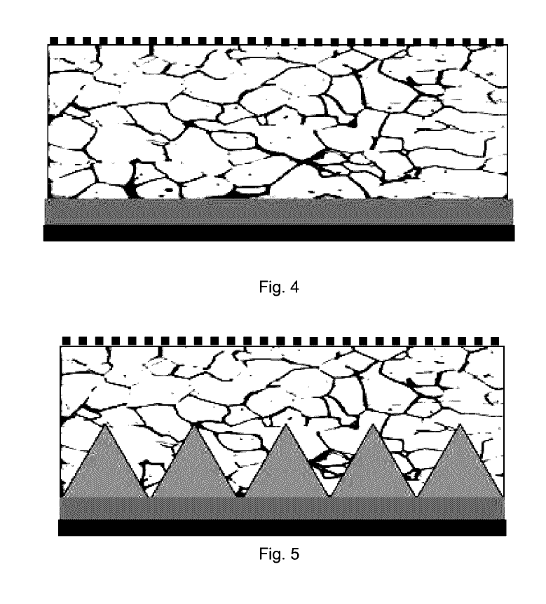

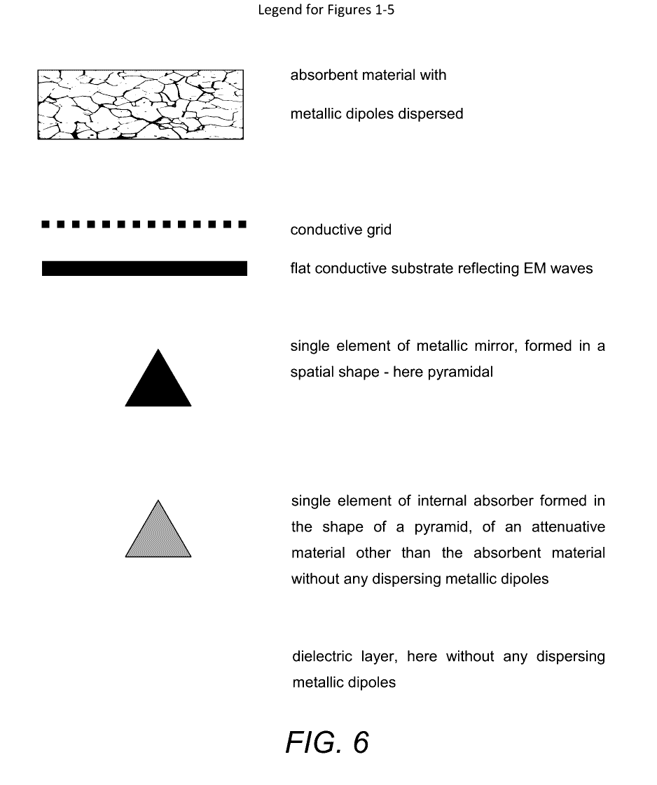

### DETAILED DESCRIPTION OF THE INVENTION

### Example 1

A flat absorber made of an absorbent material in which metallic dipoles are stochastically suspended, placed on a conductive substrate in the form of a metallic mirror. On the surface of the absorber, a metallic grid with regular shapes of meshes and with two-dimensional or spatial (2D or 3D) geometrical structure is placed.

### Example 2

A flat absorber as in Example 1, placed on a conductive substrate in the form of a metallic mirror shaped in regularly distributed spatial structures, e.g. pyramids with appropriately selected sizes. On the surface of the absorber, a metallic grid with regular shapes of meshes and with two-dimensional or spatial (2D or 3D) geometrical structure is placed.

### Example 3

A flat absorber, containing a conductive substrate in the form of a metallic mirror onto which spatial elements are glued, in the shape of pyramids, made of a mass attenuating EM waves different than the one used so far, thereby forming, from these elements, regular spatial structures which are sunken in the previously used absorbent material with metallic dipoles stochastically suspended therein. On the surface of the absorber, a metallic grid with regular shapes of meshes and with two-dimensional or spatial (2D or 3D) geometrical structure is placed.

### Example 4

A flat absorber as in Example 1, made of an absorbent material, with metallic dipoles suspended therein, and placed on a dielectric layer separating it from a conductive substrate in the form of a metallic mirror. On the surface of the absorber, a metallic grid with regular shapes of meshes and with two-dimensional or spatial (2D or 3D) geometrical structure is placed.

### Example 5

A flat absorber as in Example 1, constructed from a dielectric layer placed on a flat conductive substrate in the form of a metallic mirror onto which elements are glued, in the shape of pyramids, made of a mass attenuating EM waves different than the one used so far, thereby forming, from these elements, regular spatial structures which are sunken in the previously used absorbent material with metallic dipoles stochastically suspended therein. On the surface of the absorber, a metallic grid with regular shapes of meshes and with two-dimensional or spatial (2D or 3D) geometrical structure is placed.

Attenuative materials used in the absorbers according to the invention must be characterised by appropriate physical properties, i.e. their basic physical state or/and method of their preparation must allow for the introduction of a sufficient number of metallic dipoles thereto and for easier formation of appropriate shaped blocks/flat structures, e.g. plates or spatial structures, e.g. pyramids, crates, cubes, etc., from them.

This significantly limits the amount of known substances used so far as classic absorbent materials, e.g. solid ferrites, due to the high-temperature process of formation thereof, as well as ferromagnetic and ferrimagnetic metals or alloys thereof.

Therefore, absorbent masses containing conductive dipoles must
have an incoherent structure (e.g. extrudable, miscible, etc.), both at the stage of introducing dipoles, and in the form of the final, ready product, or
have an incoherent structure at the stage of mixing with dipoles, but achieve cohesion, by chemical processes or physical processing, after a certain time since the introduction of these dipoles to the attenuative mass.

Such characteristics are usually exhibited by composite magnetic materials in which metallic powders, ferrite powders and other compounds having ferrimagnetic and ferromagnetic properties or mixtures thereof, homogeneously bound with a polymeric binder, are used.

In turn, absorbent shaped blocks (pyramids, crates, etc.) can have both almost coherent and coherent consistency, and be made of, e.g.:
solid ferrite
solid magnetic metals and metallic alloys
solid composite materials obtained using chemically and thermally hardenable polymers
solid composite materials obtained by compression but, most importantly, they must have different dielectric and magnetic properties than the primary attenuative material forming the free space absorber.

As already emphasised, these shaped blocks can contain also metallic dispersing dipoles introduced thereto.

Shape, size and material composition of the spatial elements can be selected based on simulation analyses so that the most effective absorption effect usually expressed in units of reflexivity (−dB) in a given frequency range of EM waves is obtained.

The purpose of the spatial elements formed from additional attenuative material is to additionally “attenuate” the waves which have not been absorbed into the absorbent material, on a specifically shaped surface of the second, “internal”, this time “geometric” absorber.

In the case of shaped blocks formed from a different attenuative material than the primary mass of the absorber, their surface acts like the surface of the geometric free space absorber in air, with the difference that there is the attenuative mass instead of the air.

Additionally, covering the surface of the conductive substrate in the form of a metallic mirror with a dielectric layer with selected thickness and dielectric parameters (∈′ and ∈″) leads to a situation in which an EM wave incident on the absorber, having passed through the upper absorbent layers (absorbent mass or absorbent mass+spatial attenuative elements) reaches the conductive substrate in the form of a metallic mirror through the said dielectric layer and having been reflected from this mirror, returns to the attenuative layer (absorbent material or spatial attenuative elements), and undergoes secondary processes of deflection and reflection from its surface, and after a partial entry thereto, it undergoes another dispersion process on metallic dipoles together with another, secondary absorption in the attenuative mass.

Introduction of metallic dipoles to the dielectric layer in a stochastic manner is very advantageous.

Such a solution of the discussed absorbers multiplies effects of attenuation of waves by them in specific ranges of their lengths.

Metallic grids used in free space absorbers can have regular or irregular shape of meshes and have almost flat structure or, very advantageously, spatial structure, e.g. of honeycomb.

The solutions discussed in detail above related both to the use of metallic dipoles in the attenuative mass, and to the structure and construction of the absorbers themselves, were based on examples of free space absorbers having a flat structure independently of their thickness.

The frequency range of electromagnetic waves, in which the absorber according to the invention operate in a satisfactory manner depends on the following factors:
shape of the original absorber—flat, spatial,
its dimensions—mainly thickness,
attenuative properties (effectiveness), i.e. values of magnetic and dielectric permeability parameters (μ′, μ″ and ∈′, ∈″) of the substances used both as the absorbent material, and the material for the preparation of spatial elements, i.e. dispersing and attenuative, magnetic and dielectric shaped blocks sunken in the absorbent material,
concentration, length and shape of the metallic dipoles dispersing EM waves in the attenuative masses or the layer of spacing dielectric,
shape and dimensions of the spatial elements,
thickness of the dielectric layer.

A test confirming the operation of the absorber according to the invention was conducted. Measurements were performed with the method of microwave reflectometry. “Microwave Reflectometer PR-17” from Millimeter Wave Technology Inc. was used for measurements. The device was calibrated at the Institute of Communications—National Research Institute in the Laboratory of Electrical, Electronic and Optoelectronic Metrology. The attenuation was determined by measuring the intensity of the radiation reflected from the tested surface compared to the standard.

Thickness of the plates:

Standard plate: aluminum 0.3 mm+magnetic layer 0.8 mm honeycomb plate: 0.5 mm wire grid plates: 0.3-0.5 mm

Plate with Absorbent Material According to GB2379331 as a Reference

Portable Reflectometer Measurement Data

| Frequency | Loss |
|---|---|
| (GHz) | (dB) |
| 4.000 | −0.03 |
| 4.500 | −0.02 |
| 5.000 | −0.06 |
| 5.500 | −0.15 |
| 6.000 | −0.18 |
| 6.500 | −0.12 |
| 7.000 | −0.06 |
| 7.500 | −0.04 |
| 8.000 | −0.02 |
| 8.500 | −0.02 |
| 9.000 | −0.02 |
| 9.500 | −0.02 |
| 10.000 | −0.02 |
| 10.500 | −0.03 |
| 11.000 | −0.05 |
| 11.500 | −0.05 |
| 12.000 | −0.08 |
| 12.500 | −0.10 |
| 13.000 | −0.08 |
| 13.500 | −0.05 |
| 14.000 | −0.04 |
| 14.500 | −0.03 |
| 15.000 | −0.01 |
| 15.500 | −0.01 |
| 16.000 | −0.02 |
| 16.500 | −0.02 |
| 17.000 | −0.01 |
| 17.500 | −0.01 |
| 18.000 | −0.01 |

Plate with Absorbent Material According to GB2379331 and with Conductive Substrate and Grid

Portable Reflectometer Measurement Data

| Frequency | Loss |
|---|---|
| (GHz) | (dB) |
| 4.000 | −0.29 |
| 4.500 | −0.35 |
| 5.000 | −0.57 |
| 5.500 | −0.89 |
| 6.000 | −1.27 |
| 6.500 | −1.35 |
| 7.000 | −1.33 |
| 7.500 | −1.31 |
| 8.000 | −1.78 |
| 8.500 | −2.23 |
| 9.000 | −2.59 |
| 9.500 | −2.78 |
| 10.000 | −2.77 |
| 10.500 | −2.89 |
| 11.000 | −3.03 |
| 11.500 | −3.45 |
| 12.000 | −3.78 |
| 12.500 | −4.99 |
| 13.000 | −5.35 |
| 13.500 | −6.45 |
| 14.000 | −6.67 |
| 14.500 | −7.04 |
| 15.000 | −8.22 |
| 15.500 | −9.32 |
| 16.000 | −10.48 |
| 16.500 | −12.80 |
| 17.000 | −17.34 |
| 17.500 | −20.63 |
| 18.000 | −22.38 |

1. A free space absorber, comprising:
a conductive substrate reflecting EM waves and being based on an absorbent material containing conductive dipoles dispersing EM waves; and
a conductive grid located on a surface of the substrate.

2. The absorber according to claim 1, wherein said absorbent material is comprised of at least one of group consisting of: a dielectric material, a magnetic material, and a magnetic dielectric material.

3. The absorber according to claim 1, wherein the substrate reflecting EM waves is shaped as one of a group consisting of: planar and regular spatial structures.

4. The absorber according to claim 1, wherein said conductive dipoles are comprised of at least one of a group consisting of: metallic and non-metallic antennas dispersing EM waves.

5. The absorber according to claim 1, wherein said conductive grid is metallic or non-metallic.

6. The absorber according to claim 1, wherein said conductive grid has a two-dimensional or three-dimensional structure.

7. The absorber according to claim 1, wherein said conductive grid is placed on the surface of the absorbent material.

8. The absorber according to a claim 1, wherein said conductive dipoles are distributed stochastically or non-stochastically in the absorbent material.

9. The absorber according to claim 1, wherein said conductive dipoles have equal or unequal dimensions and shapes.

10. The absorber according to claim 1, further comprising: a layer of dielectric material located on an underside of the absorbent material.

11. The absorber according to claim 10, wherein said layer of dielectric material contains the conductive dipoles dispersing EM waves.

12. The absorber according to claim 10, wherein said conductive dipoles dispersing EM waves contained in said layer of dielectric material comprises metallic and/or non-metallic antennas dispersing EM waves being distributed stochastically or non-stochastically, wherein the antennas have equal or unequal dimensions and shapes.

13. The absorber according to claim 1, further comprising: additional spatial elements comprised of attenuative materials.

14. The absorber according to claim 13, wherein said attenuative materials are comprised of dielectric or magnetic attenuative materials having different magnetic and dielectric parameters than the absorbent material.

15. The absorber according to claim 13, wherein said spatial elements are located within the absorbent material.

16. The absorber according to claim 13, wherein said spatial elements are located on a dielectric layer.

17. The absorber according to claim 13, wherein said spatial elements are covered with an excess of absorbent mass.

18. The absorber according to claim 1, further comprising a layer of dielectric material separating the conductive substrate from the absorbent material.
